(19) United States
(12) Patent Application Publication
(10) Pub. No.: US 2022/0347052 A1
(43) Pub. Date: Nov. 3, 2022

(54) Vial

(71) Applicant: David Lee Carter, Vance, AL (US)

(72) Inventor: David Lee Carter, Vance, AL (US)

(21) Appl. No.: 17/246,731

(22) Filed: May 3, 2021

(51) Int. Cl. A61J 1/14

(52) U.S. Cl. CPC A61J 1/14

(57) ABSTRACT

A vial container is disclosed to have a base, body, and top portion. The body portion is structured to have at least three flat sides and an optional neck or collar to attach lids or caps. The inner cavity with longitudinal corners of adjoining sides provide a method to accumulate remaining medicinal elements for extraction.

### BACKGROUND

The commonly used body structure of medicinal vials is a cylinder or round shape, which decreases the inner volume space for storage of medicinal elements in the vial. The common body shape also limits the number of vial containers that can be stored in a given space for shipping, refrigeration, or shelf storage. When common vials are in use, the total extraction of medicinal elements isn't efficient due to the round shape. This contributes to waste, and reduces the total quantity of doses that may have otherwise been administered.

### BRIEF SUMMARY

In summary, the structural shape of the embodiment increases the volume of unit doses of the medicinal element stored within the container. The external structure increases the number of vial containers that can be stored or stacked in storage space e.g., shipping or refrigeration space. The embodiment inner cavity structure provides a more efficient method of extraction of final unit doses reducing waste.

### DETAILED DESCRIPTION

The embodiment described herein is directed toward the vial container structure and shape. The embodiment includes an open top portion 5 with an optional neck or collar 10 for attaching a cap or lid, a body portion 15 with at least three flat sides 20, and a closed base 25. The embodiment is not limited to various caps or lids that may be attached. The inner cavity has longitudinal corners 30 formed by the adjoined sides of the body.

### DESCRIPTION OF DRAWINGS

FIG. 1 illustrates a perspective view of an example embodiment with a body of four sides coupled with a neck FIG. 2 illustrates a perspective view of an example embodiment with a body of four sides without a neck FIG. 3 illustrates a perspective view of an example embodiment with a body of three sides without a neck

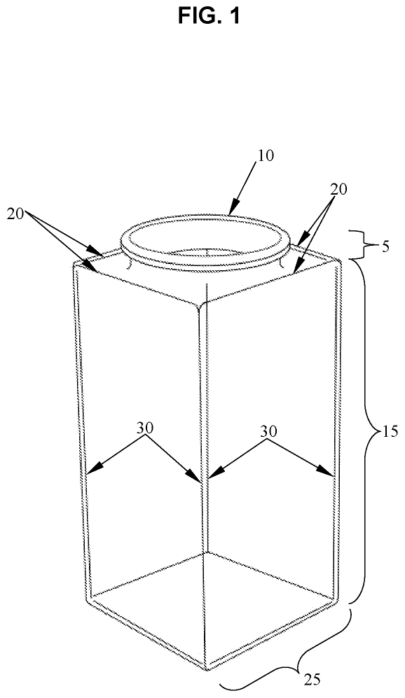

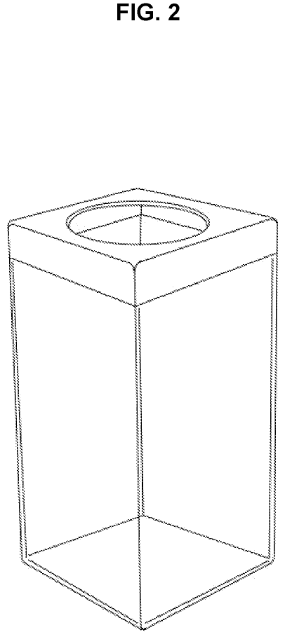

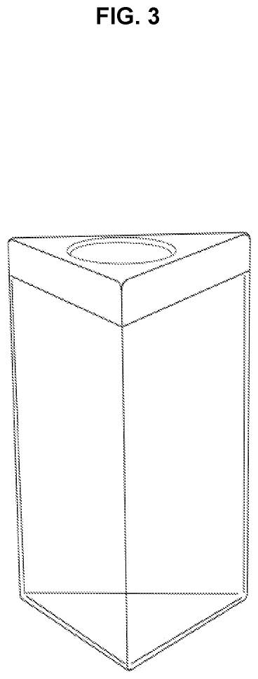

1. An apparatus for containment of medicinal elements, composing;

2. A closed base bottom portion;

3. A body portion with at least three sides;

4. A top portion with an opening;

5. An optional neck coupled to said body.

6. The apparatus of claim 1 wherein said body #3 increases volume of containment

7. The apparatus of claim 1 wherein said body #3 increases shipping and shelf storage

8. The apparatus of claim 1 wherein inner edges of adjoined sides of said body #3 is tilted on axis toward any corner of said base #2 provides a method for extraction of medicinal elements
